(19) United States
(12) Patent Application Publication
(10) Pub. No.: US 2005/0006017 A1
(43) Pub. Date: Jan. 13, 2005

(54) Tire having a carcass portion in the shape of a truncated cone

(75) Inventors: Roger C. Cottrell, Simpsonville, SC (US); Walter L. Willard JR., Chamalieres (FR)

Correspondence Address: BURNS DOANE SWECKER & MATHIS L L P, POST OFFICE BOX 1404, ALEXANDRIA, VA, 22313-1404, US

(73) Assignee: MICHELIN RECHERCHE ET TECHNIQUE S.A.

(21) Appl. No.: 10/409,903

(22) Filed: Apr. 9, 2003

Related U.S. Application Data
(63) Continuation of application No. PCT/EP01/11573, filed on Oct. 8, 2001.

(30) Foreign Application Priority Data
Oct. 10, 2000 (WO) PCT/US00/27879

(51) Int. Cl. B60C 17/00; B60C 3/00; B60C 15/00; B60C 9/02

(52) U.S. Cl. 152/454; 152/539; 152/550; 152/517

(57) ABSTRACT

A tire is described having a carcass structure anchored in each side of the tire in a bead, a reinforced summit, and two sidewall portions joining the summit, each bead having a base, which is intended to be mounted on the tire's design mounting rim, and extended radially upward by one of said sidewall portions, each bead further having an anchoring zone for anchoring the carcass in the bead, wherein between the anchoring zone and a transition zone along the respective sidewall portion, the carcass structure extends substantially linearly, forming a substantially linear portion.

### CROSS REFERENCE TO RELATED APPLICATIONS

This application is a continuation of international PCT application Serial No. PCT/EP01/11573, filed Oct. 8, 2001, which was published. in English as WO 02/30687 on Apr. 18, 2002, which is a continuation of international PCT application Serial No. PCT/US00/27879, filed Oct. 10, 2000, which was published in English as WO 02/30687 on Apr. 18, 2002.

### BACKGROUND OF THE INVENTION

The invention relates to a tire, more specifically to a pneumatic tire capable of continued mobility in a deflated condition.

Various tire constructions have been proposed for pneumatic runflat tires, i.e., tires that normally operate in an inflated condition but which also permit a limited operation in a deflated condition. These tire constructions are generally formed of one or more generally radial carcasses which are turned up around one or more bead wires arranged in each bead, forming a wide curvilinear portion around the bead wires. The immediate consequence of such an arrangement is that the carcass path, to turn around the bead wire, automatically passes in the radially inner portion of the bead, between the bead wire and the axially inner limit of the sidewall, then turns underneath the bead wire and arrives in the bead axially outer zone. Such a path gives limited flexibility to the designer who can not provide a wide variety of configurations. Such a circular or curvilinear path of the carcass occupies a large volume.

To obtain the desired mobility in the deflated condition, many of these tires further employ sidewalls which are reinforced and thickened by interposing additional rubber layers between the carcasses or between the carcasses and the tire inner liner.

It is also important to provide proper deflated bead retention, so that the runflat tire remains seated on the rim during deflated operation.

Many solutions have been proposed including mechanical bead locks, special rim profiles or bead wire bundles of elongated cross-section. The elongated bead wire bundle functions both to anchor the carcass in the bead to resist tensile forces developed in the carcass and to retain the bead on the rim seat during deflated operation. This dual function necessitates design compromises.

U.S. Pat. No. 5,660,656 describes a tire comprising a carcass which is anchored in the bead portion with an arrangement of circular reinforcing wire or cord disposed beside the carcass. Such an arrangement does not necessitate the use of a turned up portion around the bead wire. However, the anchoring zone is placed or oriented such as to guide the carcass towards the inner portion of the sidewall.

### BRIEF SUMMARY OF THE INVENTION

The invention provides a tire comprising a carcass structure anchored in each side of the tire in a bead, a reinforced summit, the sidewall portions joining said summit, each bead having a base, which is intended to be mounted on the tire's design mounting rim, and being extended radially upward by one of said tire sidewall portions, each bead further comprising an anchoring zone for anchoring said carcass in said bead, wherein between said anchoring zone and a transition zone along the respective sidewall portion, said carcass structure extends substantially linearly, forming a substantially linear portion.

Considered in three dimensions, between the anchoring zone and the transition zone along the sidewall portion, the carcass structure is in the shape of a truncated cone.

This optimized carcass path allows optimal distribution of stresses during deflated operation. The even distribution provides reduction in peak values and contributes to increase deflated operation endurance. The specific path permits reducing mass with the elimination of material not required to provide continued mobility. A thinner wall thickness also provides improved comfort and rolling resistance.

Such a tire carcass path is more advantageous with high nominal aspect ratio, i.e., a tire with “tall” sidewall, for instance with sidewall height H over 120 mm. This can allow improvement in 0-psi durability for tires operated in “straight-line”. This is particularly appropriate for straight line highway driving typical of U.S. interstate highways.

Such a tire, though it may be used as a standard type tire, is particularly adapted for continued mobility in a substantially deflated condition.

Preferably, said substantially linear portion extends substantially radially outwardly from the axially inner side portion of the bead towards the axially outer side portion of the sidewall.

The carcass structure may thus follow a path in closer relationship to the tire wall profile and orientation. In fact, in the bead zone, the tire wall usually follows a path that extends substantially radially outwardly from the axially inner side portion of the bead to the axially outer side portion of the sidewall. It is particularly advantageous to provide a carcass structure path with an angle similar to the angle of the tire sidewall.

The carcass structure position in the bead and in the sidewall, rather spaced apart from the interior of the tire is particularly advantageous. It provides space to dispose a runflat insert, thereby making a partial suppression of the inner liner possible along the sidewall. In fact, in such a case, the runflat insert provides the necessary air barrier. It also provides improved inflated handling and improved deflated durability. This gives better flexibility to trade deflated performance for normal inflated performance, for instance better comfort, mass, etc.

The substantially linear portion advantageously defines an angle between 110 to 140 degrees, and preferably between 120 and 130 degrees, with respect to the axial direction, the tire being in a similar position as when mounted on its design mounting rim and inflated at a nominal pressure. In a specific example, this angle substantially corresponds to the angle or general orientation of the median portion or central line of the tire sidewall in the corresponding area.

The length of said substantially linear portion is preferably between 20% and 50% of the tire side height H and most preferably between 20% and 40% of the tire side height H. The tire side height H, as shown in FIG. 2, is the length of a rectilinear radial line extending from the bottom or radially inward portion of the anchoring zone to the base or radially inward portion of the summit reinforcement layers.

The transition zone substantially corresponds to the portion of the carcass path radially outward of the substantially linear portion, where the path changes direction or shape. Radially outward of the transition zone, the carcass is provided with a second portion, extending radially from the transition zone to the axially outer portion of the summit.

In a first variant, the second portion comprises a substantially curvilinear portion.

Preferably, the substantially curvilinear portion is provided with a larger radius than the radius in said transition zone.

The anchoring zone is advantageously provided with at least one first bead reinforcement, at least partially bordering said carcass structure and a high modulus elastomeric material cooperating with said bead reinforcement and with said carcass structure for anchoring said carcass structure in the beads.

This type of cooperation between the carcass structure and bead reinforcements provides design flexibility in many aspects. For instance, the carcass structure may enter the bead in different configurations or angles. It may enter the bead in locations different than the radial inner side of the wall, etc. Moreover, such an anchoring zone is compact, very strong and reliable.

The bead reinforcement includes substantially circumferentially oriented cords laterally bordering the carcass structure on at least one side. Such an arrangement provides the possibility of taking up the tension developed in the carcass during inflated or deflated use of the tire.

The tire of the invention preferably comprises a runflat insert provided in the axially inner portion of the sidewall. The insert is advantageously substantially airtight. Efficient impermeability is possible when a substantially thick runflat insert is used. For instance, a runflat insert having seven times the thickness of a known type butyl based rubber or elastomeric material would give a similar resistance to diffusion than such a thin layer of a butyl based material. With such an arrangement, no inner liner is required in most of the sidewall portion.

Most preferably, the bead reinforcement defines an angle between 110 to 140 degrees, and preferably between 120 and 130 degrees, with respect to the axial direction, the tire being in a similar position as when mounted on its design mounting rim and inflated at a nominal pressure.

### BRIEF DESCRIPTION OF THE DRAWINGS

FIG. 1 illustrates the sidewall and bead portion of a runflat tire according to the invention, taken along a meridian plane through the axis of rotation;

FIG. 2 illustrates the sidewall and bead portion of a second embodiment of a runflat tire according to the invention, taken along a meridian plane through the axis of rotation;

FIG. 3 illustrates the sidewall and bead portion of a third embodiment of a runflat tire according to the invention, taken along a meridian plane through the axis of rotation;

FIG. 4 illustrates the sidewall and bead portion of a fourth embodiment of a runflat tire according to the invention, taken along a meridian plane through the axis of rotation, and having three carcass layers in the sidewall and two in the bead; and

FIG. 5 is an enlarged perspective view of the bead portion of a runflat tire corresponding to the fourth embodiment of the invention showing the common circumferential disposition of the first and second carcass layers.

### DETAILED DESCRIPTION OF THE INVENTION

“Axial” and “axially” mean the lines or directions that are parallel to the axis of rotation of the tire.

“Radial” and “radially” mean directions radially toward or away from the axis of rotation of the tire.

“Angle defined with respect to an axial direction” means an angle measured axially and radially outwardly from the innerside of the tire; such an angle is between 0 and 180 degrees.

The tire of the invention comprises a bead 1 provided with a seat 12, specially adapted to fit on the tire mounting rim. The bead extends substantially radially to the sidewall 13. The summit 11 comprises reinforcement layers of known type.

The tire comprises a carcass structure 5, extending from bead to bead or leaving a gap between two half structures, for instance in the substantially median portion of the summit. The radially innermost extent of the carcass structure 5 terminates in an anchoring zone 2 of the bead 1. Advantageously, the carcass structure is not turned up around bead cores or other bead reinforcement. That is to say, each axial coordinate defining the profile of the carcass structure has a unique radial position for each radial position less than that of the tire equator. The carcass structure is anchored in the bead portion by a bead reinforcement 3. A preferred embodiment of such a reinforcement comprises a cord arrangement 4 provided with at least one substantially circumferentially oriented cord laterally bordering the carcass structure on at least one side. In this instance “anchored” in the bead portion means that the cord arrangement resists the tension developed in the carcass structure during inflated or deflated use of the tire by the adherence of the carcass reinforcing structure laterally with the cord arrangement rather than being wound around a traditional bead core.

The mechanical properties of the anchoring zone 4 are optimized in using an elastomeric bead filler having a high elasticity modulus.

Other alternative carcass anchoring or dispositions of the carcass layers in the bead portion have been disclosed in U.S. Pat. No. 5,660,656 to Herbelleau et al and are incorporated herein by reference.

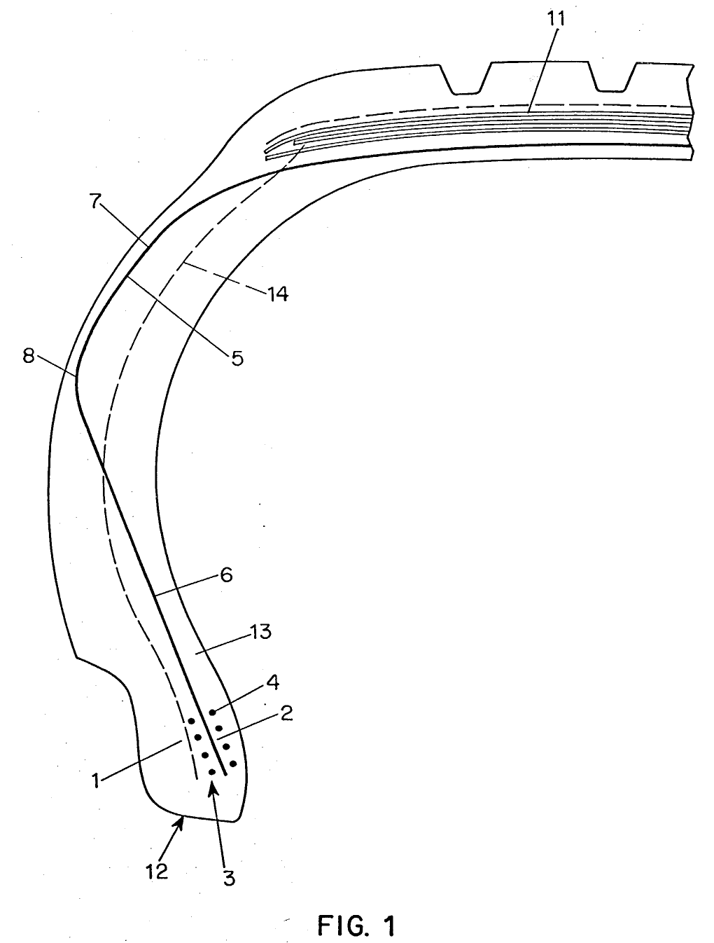

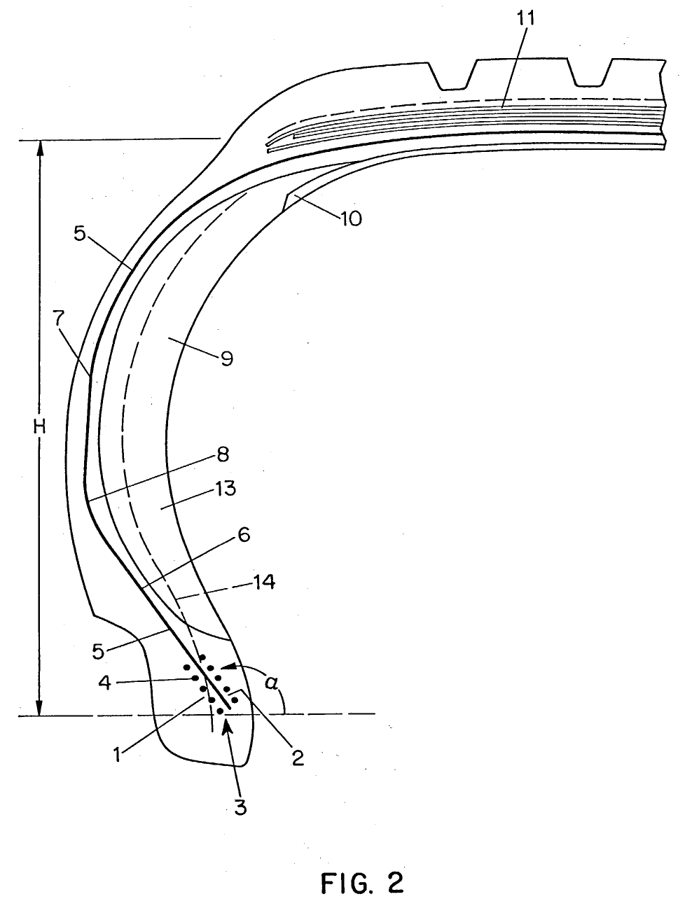

As shown, for instance, in the embodiments illustrated in FIGS. 1 and 2, the carcass structure 5 is provided with a substantially linear portion 6. This portion extends between the anchoring zone 2 and a transition zone 8. The general orientation of the portion 6 is preferably slightly inclined from the bead 1 axially inner portion towards a radially and axially outer portion of the wall.

Considered in three dimensions, between the anchoring zone and the transition zone along the sidewall portion, the carcass structure is in the shape of a truncated cone.

The length of said substantially linear portion 6 is preferably between 20% and 50% of the tire side height H and most preferably between 20% and 40% of H. The tire side height H, as shown in FIG. 2, is the length of a rectilinear radial line extending from the bottom or radially inward portion of the anchoring zone to the base or radially inward portion of the summit reinforcement layers.

The transition zone 8 substantially corresponds to the portion of the carcass path radially outward of the substantially linear portion, where the path changes direction or shape. Radially outward of the transition zone, the carcass is provided with a second portion, extending radially from the transition zone to the axially outer portion of the summit. The preferred beginning of the transition zone is between 20% to 50% of the tire side height H, and most preferably around 40% of H.

The transition zone 8 preferably comprises a substantially curvilinear portion disposed between the substantially linear portion 6 and the second portion 7, connecting these two portions 6 and 7 of the carcass. A small radius of the transition zone 8 permits concentration of the change of orientation of the carcass path in a compact area.

At the transition zone 8, the carcass structure is no longer rectilinear, but rather curvilinear. From this zone towards the summit zone, the general shape and orientation of the carcass structure 5 is such that it extends from the transition zone 8 towards the tire summit in a path oriented axially inwardly and radially outwardly, forming the second portion or top wall portion 7.

Preferably, as shown in FIG. 1, the second portion 7 extends in the outer portion of the wall with respect to the center line 14. The second portion 7 extends up to the summit where it may or not be interrupted, depending on the embodiment.

In the embodiment shown in FIG. 1, the top wall portion 7 has a substantially curvilinear profile, with a large radius.

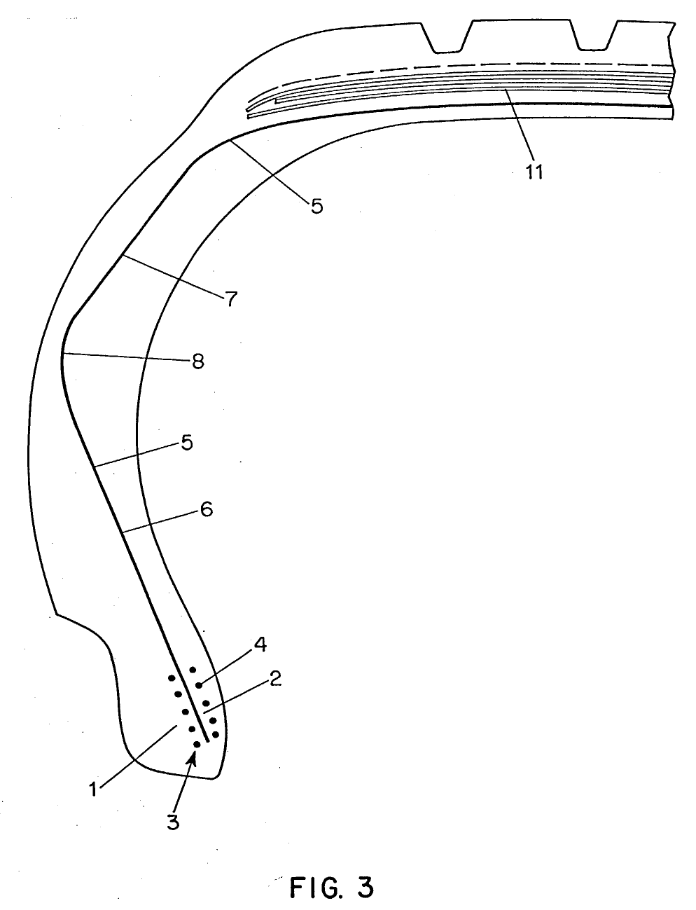

In the embodiment shown in FIG. 3, the top wall portion 7 has a substantially rectilinear profile between the transition zone 8 and the border of the summit. Thus, in this embodiment, the carcass path is provided with two substantially linear portions 6 and 7.

In fact, in this upper section of the tire wall, it is also advantageous to adapt the carcass structure path to the tire wall thickness and geometry, similarly to the first rectilinear portion. Depending on the sidewall profile, it may be more appropriate to provide a carcass structure either substantially rectilinear on a more or less long proportion, or a curvilinear path.

The tire of the invention preferably comprises a runflat insert 9 provided in the axially inner portion of the sidewall (FIG. 2). The insert is advantageously substantially airtight. Efficient impermeability is possible when a substantially thick runflat insert is used. With such an arrangement, no inner liner is required in most of the sidewall portion. This enables the use of a substantially airtight inner liner 10 such as a butyl based inner liner in a limited portion of the tire profile, for instance along the summit portion, to protect the summit from diffusion.

In the embodiment shown in FIG. 2, the anchoring zone 2 is substantially inclined. The general orientation of the zone 2 is preferably slightly inclined from the bead radially and axially inner portion towards a radially and axially outer portion of the bead. The angle a, measured with respect to an axial plane, indicates the inclination of the inner portion of the carcass structure embedded in the anchoring zone 2. This inclination is advantageously between 110 and 140 degrees, and preferably between 120 and 130 degrees, with respect to the axial direction, the tire being in a similar position as when mounted on said design mounting rim and inflated at a nominal pressure. The cooperating cords of the arrangement 4 are preferably disposed or aligned to form a substantially similar angle.

Such an arrangement with inclined anchoring zone or inclined portion of the carcass path within the anchoring zone provides a general path of the anchoring zone substantially aligned with respect to the portion 6 of the carcass structure. The traditional curved carcass portion in the radially outer zone of the anchoring zone may thus be reduced or even suppressed, as shown in FIG. 2. This inclined zone provides a good level of bead retention when the tire is deflated. It also permits the disposition of the carcass structure axially outward with respect to the center line 14. As shown in FIG. 2, radially outward of the anchoring zone 2, the carcass path extends in the axially outer portion of the sidewall.

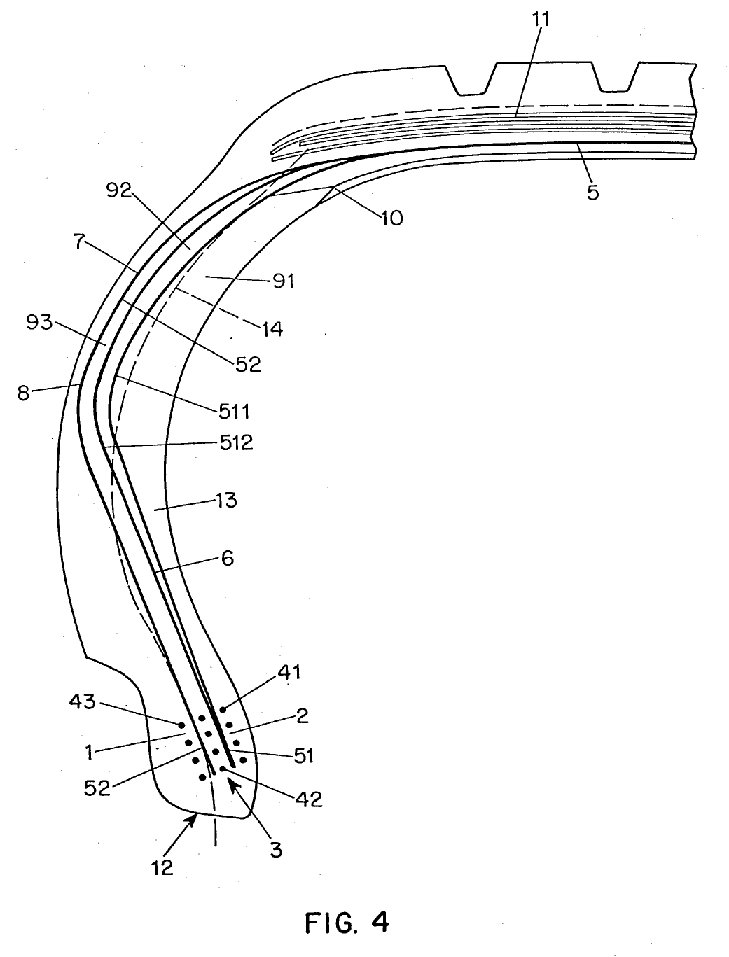

FIG. 4 illustrates a fourth embodiment of the invention in which the carcass structure 5 has more than one carcass layer within some portion of the tire. The carcass structure 5 comprises one circumferential alignment of cords in the summit 11. In the sidewall portion 13 of the tire, the carcass structure 5 is divided in three circumferential alignments of radial cords 511, 512 and 52. These three circumferential alignments of cords progressively diverge axially away from each other. In the bead 1, the two circumferential alignments of cords 511 and 512 join and give a common circumferential alignment of cords 51. Accordingly, in the bead 1, there are two circumferential alignment of cords 51 and 52.

This carcass structure is very flexible and allows placing the carcass cords where they are most useful. For instance, the density of cords of carcass layer 52 is superior to the carcass density of cords of the carcass layers 511 and 512. The cords of the outer carcass layer are subjected to high-tension stress-strain cycles in inflated and deflated operation. These cords are well designed to support these high-tension cycles and the number of cords is defined accordingly. The cords of the inner carcass layer are subjected in deflated operation to stress-strain cycles with compression. In this case, it is the rubber mixes, which are well designed to support-these compression stresses. The number of cords need not be high. It allows also a limited thickness of the carcass structure in the summit and an appropriate anchoring in the bead portion. The anchoring of the carcass structure 5 is achieved by three windings 41, 42, 43 of circumferential oriented cords, which axially border the two circumferential alignments of cords 51 and 52 of the carcass structure with the interposition of a high modulus rubber layer.

Advantageously, runflat inserts 92 and 93 are placed in the sidewall between the carcass layers 511-512 and 512-52 respectively, and, as in the previous embodiments, runflat insert 91 is placed between the carcass structure 5 and the inner side of the tire in order to have a good 0-psi performance. Preferably, these runflat inserts are in direct contact with the cords of the adjacent carcass layers. This means that the rubber mixes constituting the runflat inserts are in intimate contact with at least part of the outer circumference of the cord, and that during the building of the tire, no usual cushion rubber mix of low modulus of elasticity has been used. Accordingly, the sidewall structure has a better durability in deflated operation.

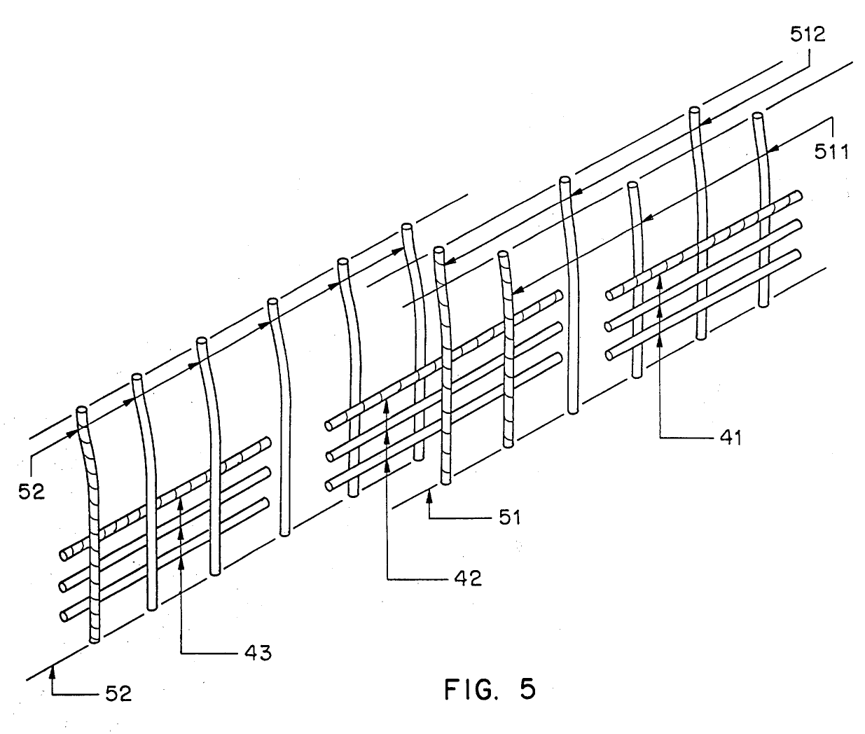

FIG. 5 illustrates the structure of the radial and circumferential cords in the bead 1 of the fourth embodiment. In the anchoring zone, axially outward, we have the first circumferentially oriented winding 41, the first carcass circumferential alignment 51, the second circumferentially oriented winding 42, the second carcass circumferential alignment 52 and the third circumferentially oriented winding 43. Radially outwardly from the anchoring zone, the first carcass circumferential alignment 51 is divided in two carcass circumferential alignments 511 and 512. The rubber mixes are not represented in this figure for clarity. All these cords are embedded, at least in the anchoring zone, by a high modulus rubber mix. Preferably, this rubber mix has a shore A hardness over 70.

All the carcass cords presented in FIG. 5 are placed with a circumferentially shifted position, which allows them to form one sole alignment in the summit portion of the tire. This allows minimizing the thickness of the summit portion.

Within the scope of the invention, the carcass structure can also present one circumferential alignment of cords in the summit and the bead, which divide in two or three in the sidewall.

In order to position the reinforcement cords as precisely as possible, it is very advantageous to build the tire on a rigid support, for instance a rigid core imposing the shape of its inner cavity. All the components of the tire, which are disposed directly in their final place, are applied onto this core in the order required by the final architecture, without undergoing shaping at any moment of the building. In this case, the tire can be molded and vulcanized in the manner explained in U.S. Pat. No. 4,895,692, the disclosure of which is hereby incorporated by reference in its entirety.

While the invention has been described in combination with embodiments thereof, it is evident that many alternatives, modifications, and variations will be apparent to those skilled in the art in light of the foregoing teachings. Accordingly, the invention is intended to embrace all such alternatives, modifications and variations as fall within the spirit and scope of the appended claims.

Various publications are cited herein, which are hereby incorporated by reference in their entireties.

1. A tire comprising a carcass structure anchored in each side of the tire in a bead, a reinforced summit, and two sidewall portions joining the summit, each bead having a base, which is intended to be mounted on the tire's design mounting rim, and being extended radially upward by one of the sidewall portions, each bead further comprising an anchoring zone for anchoring the carcass in the bead, wherein between the anchoring zone and a transition zone along the respective sidewall portion the carcass structure extends substantially linearly, forming a substantially linear portion extending radially outwardly from an axially inner side portion of the bead towards an axially outer side portion of the respective sidewall.

2. The tire of claim 1, wherein the substantially linear portion defines an angle between 110 to 140 degrees, with respect to the axial direction, the tire being in a similar position as when mounted on the design mounting rim and inflated at a nominal pressure.

3. The tire of claim 1, wherein the substantially linear portion has a length of between 25% and 75% of the tire side height H.

4. The tire of claim 1, further comprising a runflat insert provided in an axially inner portion of the respective sidewall.

5. The tire of claim 4, wherein the insert is substantially airtight.

6. The tire of claim 2, wherein the substantially linear portion defines an angle between 120 and 130 degrees.

7. The tire of claim 1, wherein the substantially linear portion has a length of between 25% and 50% of the tire side height H.

8. The tire of claim 1, wherein the substantially linear portion has a length of about 40% of the tire side height H.

9. The tire of claim 2, wherein the substantially linear portion has a length of between 25% and 75% of the tire side height H.

10. The tire of claim 2, wherein the substantially linear portion has a length of between 25% and 50% of the tire side height H.

11. The tire of claim 2, wherein the substantially linear portion has a length of about 40% of the tire side height H.
